(19) United States
(12) Patent Application Publication
(10) Pub. No.: US 2026/0275994 A1
(43) Pub. Date: Sep. 17, 2026

(54) FAN WITH SEAL AND VACUUM OPERATED PNEUMATIC LINEAR DRIVE CONNECTED THERETO

(71) Applicant: ebm-papst Mulfingen GmbH & Co., KGaA & Co. KG, Mulfingen (DE)

(72) Inventors: Michael GAKSTATTER, Igersheim (DE); Fabian KNÖRZER, Schöntal (DE)

(21) Appl. No.: 19/563,354

(22) Filed: Mar. 11, 2026

(30) Foreign Application Priority Data
Mar. 12, 2025 (DE) 102025109463.2

(51) Int. Cl. F04D 29/08; F15B 15/14

(52) U.S. Cl. CPC F04D 29/083; F15B 15/14

(57) ABSTRACT

A fan having an inlet, an outlet, an impeller arranged therebetween configured to generate a fluid flow from the inlet to the outlet. A mechanical seal has a closed position fluidically sealing the inlet and an opened position fluidically releasing the inlet, and a pneumatic linear drive is connected to the mechanical seal and configured to move the seal from the opened position to the closed position and from the closed position to the opened position. The pneumatic linear drive is configured to automatically return the seal to the closed position and is fluidically connected to a pressure relief port arranged between the inlet and the impeller, through which a vacuum holding the seal in the opened position and/or moving it to the opened position is generatable in the pneumatic linear drive.

### RELATED APPLICATIONS

The present disclosure claims priority to and the benefit of German Application 102025109 463.2, filed on March 12, 2025, the entire contents of each of which are incorporated herein by reference.

### FIELD

The present disclosure relates to a fan with a mechanical seal and a pneumatic linear drive connected thereto, which is moveable by a vacuum generatable by a pressure relief port from a closed position fluidically sealing the inlet to an opened position fluidically releasing the inlet and may be held in the opened position.

### BACKGROUND

With some fans and particularly with fans installed in a so-called “fan wall”, it is necessary and known in the art that a backflow from an outlet to an inlet of the fan needs to be prevented if the fan is not operated, for example.

In so-called “fan walls”, in which multiple fans are arranged parallel in a common “wall”, controlling the entire flow rate generated by the fans may be performed, for example, by operating all the fans with a partial load, at which the power or speed of all the fans is reduced.

However, there are large ranges where the fans need to be operated outside their optimum efficiency range.

An alternative provides that some of the fans of the “fan wall” are significantly reduced in their power or fully shut off, and the remaining fans are operated in their efficiency range, such that, on the one hand, the desired flow rate is achieved by the operated fans, and, on the other hand, these fans are operated mainly within their optimum efficiency range.

However, we have discovered that in an efficient and cost-effective solution, a backflow of the fluid flown by the fans from the respective outlet of the fans which are shut-off or significantly reduced in their power to the respective inlet of these fans needs to be prevented.

For example, the fans significantly reduced in their power may be correspondingly controlled to prevent the backflow.

Furthermore, mechanical seals are also known, which are controlled externally and by means of corresponding control signals to fluidically seal the shut-off fans, such that no backflow may occur.

Since both operating the fans at a speed or power preventing the backflow and actively controlling an actuator are control- and energy-intensive, the solution known in the art are not satisfactory.

### BRIEF SUMMARY

Therefore, the present disclosure provides a fan with or at which a backflow from the outlet to the inlet may also be prevented when the fan or impeller is shut off.

According to the present disclosure, a fan is suggested, having an inlet or fluid inlet, an outlet or fluid outlet, and an impeller arranged therebetween, which is configured to generate a fluid flow from the inlet to the outlet. Preferably, the fluid is air. Furthermore, according to the present disclosure, the fan has a mechanical seal having a closed position fluidically sealing the inlet and an opened position fluidically releasing the inlet, such that a backflow from the outlet to the inlet through the fan is minimized or fully prevented with the seal in the closed position, and a fluid flow generated by the impeller from the inlet to the outlet is enabled with the seal in the opened position. The fan further has a pneumatic linear drive connected to the mechanical seal, configured to move the seal from the opened position to the closed position and from the closed position to the opened position. According to the present disclosure, it is provided that the pneumatic linear drive is configured to automatically return the seal to the closed position, such that the seal is automatically returnable to the closed position by returning it without a fluid flow generated by the impeller. Furthermore, the pneumatic linear drive is fluidically connected to a pressure relief port arranged between the inlet and the impeller, through which a vacuum holding the seal in the opened position and/or moving it to the opened position is generatable in the pneumatic linear drive, such that the seal may be held in the opened position at a fluid flow generated by the impeller and may be moved to the opened position by a vacuum generated by the impeller even without a generated fluid flow.

As such, the pneumatic linear drive has a basic position to which it is self-returnable by a spring, wherein the mechanical seal, in the basic position of the linear drive, is in the closed position, such that the fan comprising the linear drive and the seal automatically seals its inlet when the fan or the impeller do not generate any fluid flow, automatically opens its inlet when the impeller rotates and thereby builds up a minimum vacuum required on the inlet side of the impeller, and holds the inlet open when a fluid flow is generated.

The connection or connecting line of the pressure relief port with the pneumatic linear drive may be implemented by a hose, such as a pneumatic line, or particularly a rigid tube.

Regarding the pneumatic linear drive, it may also be provided that it is a particularly single-acting and vacuum operable pneumatic cylinder.

As mentioned above, it is preferably provided that the pneumatic linear drive is configured to automatically return the seal to the closed position using a spring. The spring may be integrated in the pneumatic linear drive or may be provided directly on or connected to the seal and acting indirectly on the linear drive via the same.

If a spring is provided, it may further have a spring constant and/or a spring force, through which a minimal vacuum generatable by the pressure relief port holds the seal in its opened position or moves it to the opened position, and/or through which the seal is moved to its closed position at a vacuum generated by the pressure relief port, that is less than the minimum vacuum.

Preferably, it is provided that the pressure relief port has a relief opening arranged in the fluid flow and fluidically facing away from the inlet, such that a dynamic related vacuum additionally becomes generatable by a venturi effect and the fluid flow passing the relief opening in the pressure relief port, and a vacuum composed of a dynamic portion and a static portion is generatable via the pressure relief port in the pneumatic linear drive.

If the seal is in its closed position, the minimum vacuum may be generated by the impeller only, such that a static portion of a pressure difference related to the rotation of the impeller between the pressure on the inlet side of the impeller or at the pressure relief port and the pressure on the outlet side of the impeller is sufficient to generate a vacuum in the linear drive, through which the seal is moved by the linear drive from the closed to the opened position.

If the seal is in its opened position, the static portion generated by the impeller may be smaller, since additionally to the static portion, a dynamic portion is generated by the fluid flow at the pressure relief port flowing from the inlet to the outlet and flown by the impeller, such that the vacuum generated in the linear drive results from the static and dynamic portion.

Preferably, the suggested fan further has an inlet nozzle forming the inlet or arranged between the inlet and the impeller, through which the fluid flowing on the inlet side is flown to the impeller. In order to maximize the vacuum generated by means of the pressure relief port in the linear drive, the pressure relief port preferably further is arranged in or integrally formed by the inlet nozzle.

As such, the inlet nozzle may have a wall defining a flow channel leading from the inlet to the impeller. The pressure relief port is configured directly on the wall or alternatively integrated directly in the wall.

Regarding the position of the pressure relief port in the inlet nozzle, it is advantageous if the port is arranged on the side of the impeller, since the fluid passing the pressure relief port then has a higher flow rate. The inlet nozzle accordingly has an opening on the inlet side and an opposite smaller opening on the impeller side, wherein the pressure relief port is arranged closer to the opening on the impeller side than to the opening on the inlet side and/or directly at the opening on the impeller side.

Although, due to the course of the inlet nozzle, the pressure relief port is therefore arranged in a region where the fluid flow opposite the region at the opening on the inlet side has an increased flow rate, it may alternatively or independently provided that the course of the flow rate in the inlet nozzle is known or defined, and the pressure relief port and particularly its relief opening may be arranged in the region of the maximum flow rate.

In order to integrally form the pressure relief port with the inlet nozzle and particularly its wall, it may be provided, for example, that the pressure relief port is configured as a sheet gill or beading which may be formed by a sheet forming the wall, for example. Alternatively, it is also possible to form the pressure relief port as a nozzle at least partially free in its circumferential direction and preferably open to the impeller, wherein the nozzle may be configured similarly to a pitot tube or a venturi nozzle.

The seal may be configured as a single-part or multi-part sliding seal, the parts of which release the inlet in the opened position and cover it in the closed position, substantially preventing or at least minimizing a backflow of the fluid from the outlet through the impeller to the inlet.

Alternatively, the seal may be configured as a bladed seal having multiple blades, the blades of which rotated to a first rotational position fluidically release the inlet in the opened position, and the blades of which rotated to a second rotational position fluidically seal the inlet in the closed position, such that, again, the backflow is substantially prevented or at least minimized.

Apart from further possible variations, the seal may also be configured as a faceplate, also referred to as an iris seal, the segments of which release the inlet in the opened position and cover and thereby fluidically sealing it again in the closed position, such that the backflow is also substantially prevented or at least minimized.

Regarding the pressure relief port or its relief opening, they have a predefined size through which the pressure relief port is configured to build up the minimum vacuum for moving the seal from the closed position to the opened position within a predefined period of time, particularly within less than 60 seconds, more particularly within less than 30 seconds.

Therefore, the relief opening is sized such that the pressure difference may balance out in a few seconds – but so little that it does not interfere with the flow and does not have any negative impact on the acoustics of the fan. In the case of a sheet gill, its size may be configured a few millimeters in width and height.

For clarification, it should be noted that a suggested fan according to present disclosure may also have multiple pressure relief ports and/or multiple seals and/or multiple linear drives.

Although a pressure relief port may be operatively connected to multiple linear drives, and/or a linear drive to multiple pressure relief ports, and a pressure relief port to one or more seals, it is preferably provided that in each case at least one pressure relief port, one linear drive, and one seal form a seal assembly, wherein the fan according to the present disclosure may have multiple seal assemblies which may cooperate to jointly fluidically seal the inlet. Alternatively, such seal assemblies may be provided as redundant, such that each seal itself may seal the inlet, and the safety is increased by the redundancy.

The features disclosed above are combinable as required, provided this is technically possible and they do not contradict one another.

### BRIEF DESCRIPTION OF THE DRAWINGS

Other advantageous developments of the present disclosure are characterized in the dependent claims or illustrated in greater detail below together with the description of the preferred embodiment of the present disclosure with reference to the figures. In the drawings:

FIG. 1 shows a fan;

FIG. 2 shows an inlet nozzle of a fan with a pressure relief port according to a first variation;

FIG. 3 shows an inlet nozzle of a fan with a pressure relief port according to a second variation;

FIG. 4 shows an inlet nozzle of a fan with a pressure relief port according to a third variation.

The figures are schematic examples. Same reference numerals in the figures indicate same functional and/or structural features.

### DETAILED DESCRIPTION

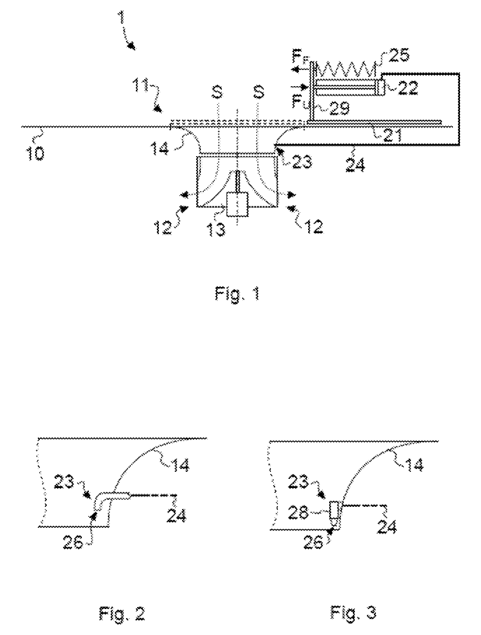

A wall 10 is illustrated in FIG. 1, in which multiple fans 1 according to the present disclosure may be integrated, such that they form a “fan wall”. If the total power of all the fans 1 is to be reduced, but the individual fans are to be operated within the optimum efficiency range, some of the fans 1 may be shut off for this. In order to avoid power losses, a backflow from an outlet 12 to an inlet 11 of the shut-off fans 1 and therefore opposite to a fluid flow S generatable by the fans needs to be prevented.

In order to achieve this object, a fan 1 according to the present disclosure is suggested, which has a seal 21 in addition to an inlet 11, an outlet 12, and an impeller 13 arranged therebetween.

In FIG. 1, the seal 21 is illustrated in its opened position fluidically releasing the inlet 11. In FIG. 1, a closed position of the seal is also illustrated in dashed lines, in which the inlet 11 is fluidically sealed, such that the undesired backflow of the fluid from the outlet 12 to the inlet 11 is prevented or at least minimized.

Although a simple single-part sliding seal is illustrated in FIG. 1, in which a plate or the like is slidable in front of the inlet 11, further variations are also possible and combinable with the aspects described below.

Regarding the impeller 13, a radial impeller is herein illustrated as an example in FIG. 1, but as a deviation and as an example, the impeller 13 may also be configured as an axial impeller.

The outlet 12 which is defined herein by the impeller 13 circularly extends around the rotational axis of the impeller 13 or the impeller 13 but may also be defined by a housing or other components fluidically downstream of the impeller 13.

According to the present disclosure, it is to be achieved that the seal 21 is moved automatically and without any external control and without any external energy supply to the closed position sealing the inlet 11 if the impeller 13 or the fan 11 is or has been shut off and does not generate any fluid flow S accordingly.

Furthermore, the seal 21 is to also be moved and held automatically and without any external control and without any external energy supply to/at the opened position fluidically releasing the inlet 11 if the impeller 13 or the fan 11 is or has been turned on and is to generate a fluid flow S accordingly.

The fan 1 further has a pneumatic linear drive 22 configured as or in the style of a single-acting pneumatic cylinder according to FIG. 1.

Furthermore, a spring 25 is provided which may also be integrated in the linear drive 22, but is connected herein parallel to the linear drive 22 to the seal 21 via a common coupling element 29.

The seal 21 is biased by the spring 25 or the spring force FF generated by the spring 25 towards its closed position and also moved towards it if there are no other forces.

The pneumatic linear drive 22 is fluidically connected to a pressure relief port 23 arranged between the inlet 11 and the impeller 13 via a connecting line 24, through which a vacuum holding the seal 21 in the opened position and moving it to the opened position is generatable in the pneumatic linear drive 22.

If the force FU generated by the vacuum by means of the linear drive 22 is greater than the spring force FF, the seal is moved to or held in the opened position.

Since the vacuum has a static portion resulting from the pressure difference between the inlet side and the outlet side of the fan 1, and a dynamic portion resulting from the fluid flow S flowing along the pressure relief port 23, the seal 21 is held in the opened position when a fluid flow S is generated, and is moved to the closed position by the spring when no fluid flow S is generated anymore.

If the seal 21 is in its closed position and the fans is turned on again, such that a fluid flow S is to be generated again, this is initially prevented. However, by rotating the impeller 13, a vacuum and therefore the static portion of the vacuum located in the linear drive 22 builds up on the inlet side of the impeller 13 and therefore in the region of the pressure relief port 23, through which the seal 21 is moved to the opened position again and a fluid flow S is generated again.

The fan 1 herein has an inlet nozzle 14 defining the inlet 11, which tapers from its inlet side to the side facing the impeller 13 and therefore also accelerates the fluid flow S towards the impeller 13. In order to increase the vacuum generatable by the dynamic portion, the pressure relief port 23 is arranged closer to the opening on the impeller side than to the opening on the inlet side, and is therefore preferably arranged in the region of the maximum flow rate of the fluid flow S.

In order to further optimize the generation of the vacuum while not affecting the acoustics and power of the fan, different variations of pressure relief ports 23 are illustrated in FIGS. 2 to 4.

For example, according to FIG. 2, the pressure relief port 23 may be configured as a simple tube, the relief opening 26 of which faces away from the inlet 11 and towards the impeller 13.

Alternatively and as illustrated in FIG. 3, the pressure relief port 23 may also be configured similarly to a pitot tube or as a nozzle 26

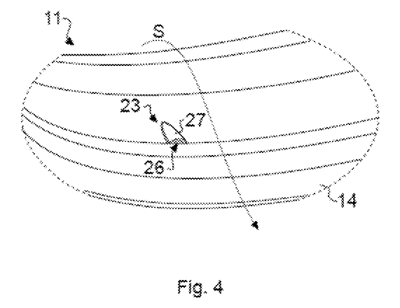

A solution not or only minimally affecting the fluid flow S and the acoustics of the fan 1 is illustrated in FIG. 4, in which the pressure relief port 23 is formed by a wall of the inlet nozzle 14 and is formed as a sheet beading.

Practice of the present disclosure is not limited to the preferred exemplary embodiments set forth above. Instead, a number of variations may be contemplated which make use of the solution presented even in fundamentally different embodiments.

1. A fan having an inlet, an outlet, an impeller arranged therebetween configured to generate a fluid flow from the inlet to the outlet, a mechanical seal having a closed position fluidically sealing the inlet and an opened position fluidically releasing the inlet, and a pneumatic linear drive connected to the mechanical seal, configured to move the seal from the opened position to the closed position and from the closed position to the opened position,
wherein the pneumatic linear drive is configured to automatically return the seal to the closed position and is fluidically connected to a pressure relief port arranged between the inlet and the impeller, through which a vacuum holding the seal in the opened position and/or moving it to the opened position is generatable in the pneumatic linear drive.

2. The fan according to claim 1,
wherein the pneumatic linear drive particularly is a single-acting, vacuum operable pneumatic cylinder.

3. The fan according to claim 1,
wherein the pneumatic linear drive is configured to automatically return the seal to the closed position using a spring,
wherein the spring has a spring constant and/or a spring force,
through which a minimal vacuum generatable by the pressure relief port holds the seal in its opened position or moves it to the opened position, and/or
through which the seal is moved to its closed position at a vacuum generated by the pressure relief port, that is less than the minimum vacuum.

4. The fan according to claim 1,
wherein the pressure relief port has a relief opening arranged in the fluid flow and fluidically facing away from the inlet, such that a vacuum composed of a dynamic portion and a static portion is generatable via the pressure relief port in the pneumatic linear drive.

5. The fan according to claim 1,
further having an inlet nozzle forming the inlet or arranged between the inlet and the impeller,
wherein the pressure relief port is arranged in the inlet nozzle and/or is integrally formed by the inlet nozzle.

6. The fan according to claim 5,
wherein the inlet nozzle has a wall defining a flow channel leading from the inlet to the impeller,
wherein the pressure relief port is configured directly on the wall or integrally in the wall.

7. The fan according to claim 5,
wherein the inlet nozzle has an opening on the inlet side and an opposite smaller opening on the impeller side,
wherein the pressure relief port is arranged closer to the opening on the impeller side than to the opening on the inlet side, and/or
wherein the pressure relief port is arranged at the opening on the impeller side.

8. The fan according to claim 1,
wherein the pressure relief port is configured as a sheet gill or beading or as a nozzle at least partially free in its circumferential direction.

9. The fan according to claim 1,
wherein the seal is configured as a single-part or multi-part sliding seal, the parts of which release the inlet in the opened position and cover it in the closed position, or
wherein the seal is configured as a bladed seal having multiple blades, the blades of which rotated to a first rotational position release the inlet in the opened position, and the blades of which rotated to a second rotational position seal the inlet in the closed position, or
wherein the seal is configured as a faceplate, the segments of which release the inlet in the opened position and cover it in the closed position.

10. The fan according to claim 4,
wherein the relief opening has a predefined size through which the pressure relief port is configured to build up the minimum vacuum for moving the seal from the closed position to the opened position within a predefined period of time, particularly within less than 60 seconds, more particularly within less than 30 seconds.
